(19) United States
(12) Patent Application Publication
(10) Pub. No.: US 2013/0090163 A1
(43) Pub. Date: Apr. 11, 2013

(54) SYSTEM AND METHOD OF GENERATING CUSTOMIZED RECOMMENDATIONS AND SETTINGS

(71) Applicant: Zachary Edson, Sacramento, CA (US)

(72) Inventor: Zachary Edson, Sacramento, CA (US)

(73) Assignee: CBS Interactive, Inc.

(21) Appl. No.: 13/269,340

(22) Filed: Oct. 7, 2011

(51) Int. Cl. A63F 13/00

(52) U.S. Cl. 463/31

(57) ABSTRACT

A system and method of generating a communication for a user of an internet website is disclosed. The method includes identifying a user of the internet website, receiving video game play data and storing the video game play data in a user profile associated with the identified user. The method also includes selecting, using a processing circuit, user-specific content based on the video game play data, generating a communication for the identified user comprising the user specific content, and transmitting the communication to the identified user.

### BACKGROUND

Some internet websites are associated with systems that serve offers such as newsletters, e-mails, alerts and other messages to their users. Such offers comprise content which can be customized based on information the system has received about the user.

Examples of such websites include multimedia websites which provide product and service reviews, product and service prices, software downloads, streaming interactive content, a product marketplace for users to buy and sell products, and a social network for users to interact and discuss products and/or services included in the website. Such a website may have a hierarchy formed in a tree structure that displays web pages devoted to each of these categories. For example, each level of the hierarchy may represent a different level of abstraction related to a particular category on the website. For example, one category of the hierarchy may represent a product marketplace, with sub-divisions including buying products, selling products, and product reviews.

Such multimedia websites have access to a wide array of data about the users who access the website, however, current websites fail to use that available data to adequately improve the overall website experience for users by using that available data to generate customized communications and user settings. Furthermore, as the volume of various non-website based interconnected media associated with smartphones, software applications, video gaming devices or platforms, cloud computing, and digital television increases, websites can implement such non-website data in generating customized communications and user settings to provide a more customized overall website experience for each of its users.

### SUMMARY

According to one exemplary embodiment, a method of generating a communication for a user of an internet website is disclosed. The method includes identifying a user of the internet website, receiving video game play data and storing the video game play data in a user profile associated with the identified user. The method also includes selecting, using a processing circuit, user-specific content based on the video game play data, generating a communication for the identified user comprising the user-specific content, and transmitting the communication to the identified user.

According to another exemplary embodiment, a method of generating a communication for a registered user of an internet website is disclosed. The method includes identifying the registered user of the internet website, receiving video game play data associated with the identified registered user, and determining, using a processing circuit, a group of registered users associated with at least one item included on the internet website based on the video game play data. The method also includes the registered user in the group of registered users associated with at least one item included on the internet website.

According to another exemplary embodiment, a method of generating a communication for a user of an internet website is disclosed. The method includes identifying a user of the internet website, receiving video game play data from a second user associated with the identified user, storing the video game play data in a user profile associated with the identified user, selecting, using a processing circuit, user-specific content based on the non-website user generated data, generating a communication for the identified user comprising the user-specific content, and transmitting the communication to the identified user.

According to yet another exemplary embodiment, one or more computer-readable media with machine-executable instructions stored thereon and when executed by one or more processors is disclosed. The machine-executable instructions implement a method including identifying a user of the internet website, receiving video game play data from a video gaming device, storing the video game play data in a user profile associated with the identified user, selecting, using a processing circuit, user-specific content based on the non-website user generated data, generating a communication for the identified user comprising the user-specific content, and transmitting the communication to the identified user.

### BRIEF DESCRIPTION OF THE DRAWINGS

FIG. 1 is a schematic diagram of a network environment comprising a client-server architecture that is used to collect user data and distribute communications according to one embodiment;

FIG. 2 is a schematic diagram of a network environment including a website hierarchy, additional user generated data, and a computing system for generating recommendations and communications according to one embodiment;

FIG. 3 is a general flow chart of a process for collecting user generated data from an identified user and generating a communication in response to the user generated data according to one embodiment;

FIG. 4 is a flow chart of a process for collecting user generated data such as video game play data from an identified user and generating a communication in response to the user generated data with respect to a particular category of items included in a website according to one embodiment;

FIG. 5 is an example of a web page included in the hierarchy of a website according to one embodiment;

FIG. 6 is an example of a web page included in the hierarchy of a website according to another embodiment;

FIG. 7 is a flow chart of a process for collecting user generated data from an identified user and altering settings associated with the identified user in response to the user generated data according to one embodiment;

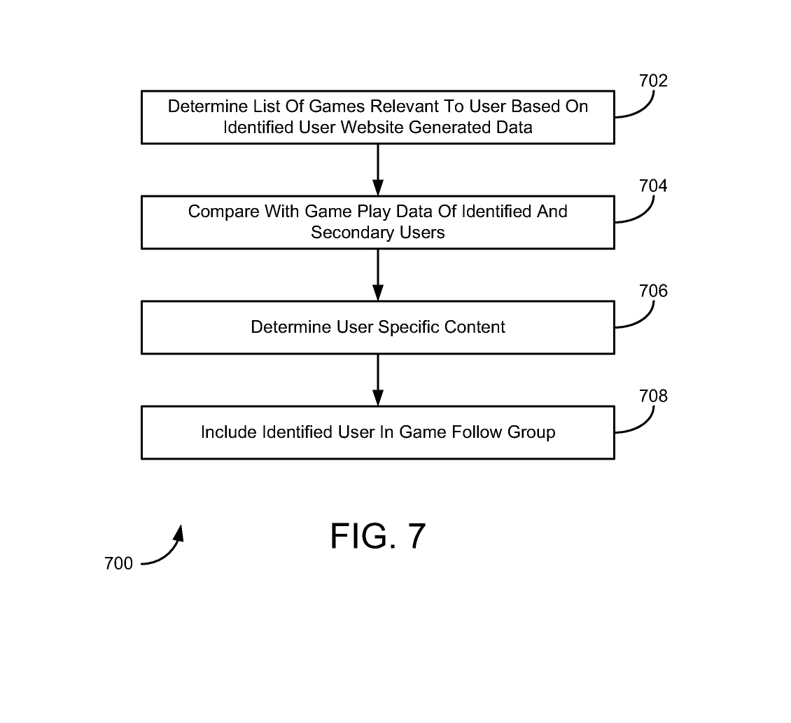

FIG. 8 is an example of a web page included in the hierarchy of a website according to another embodiment; and

FIG. 9 is a flow chart of a process for receiving video game play data to generate and distribute user-specific communications.

### DETAILED DESCRIPTION OF EXEMPLARY EMBODIMENTS

Before describing in detail the particular improved system and method, it should be observed that the invention includes, but is not limited to a novel structural combination of data/signal processing components and communications networks, and not in the particular detailed configurations thereof. Accordingly, the structure, methods, functions, control and arrangement of components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

One or more embodiments described herein may provide improved distribution of customized messages to the user of a first internet website based on user generated data collected from the first internet website as well as user generated data collected from other websites and non-website sources such as television subscription data, video game play data and non-website data from mobile devices to various exemplary embodiments.

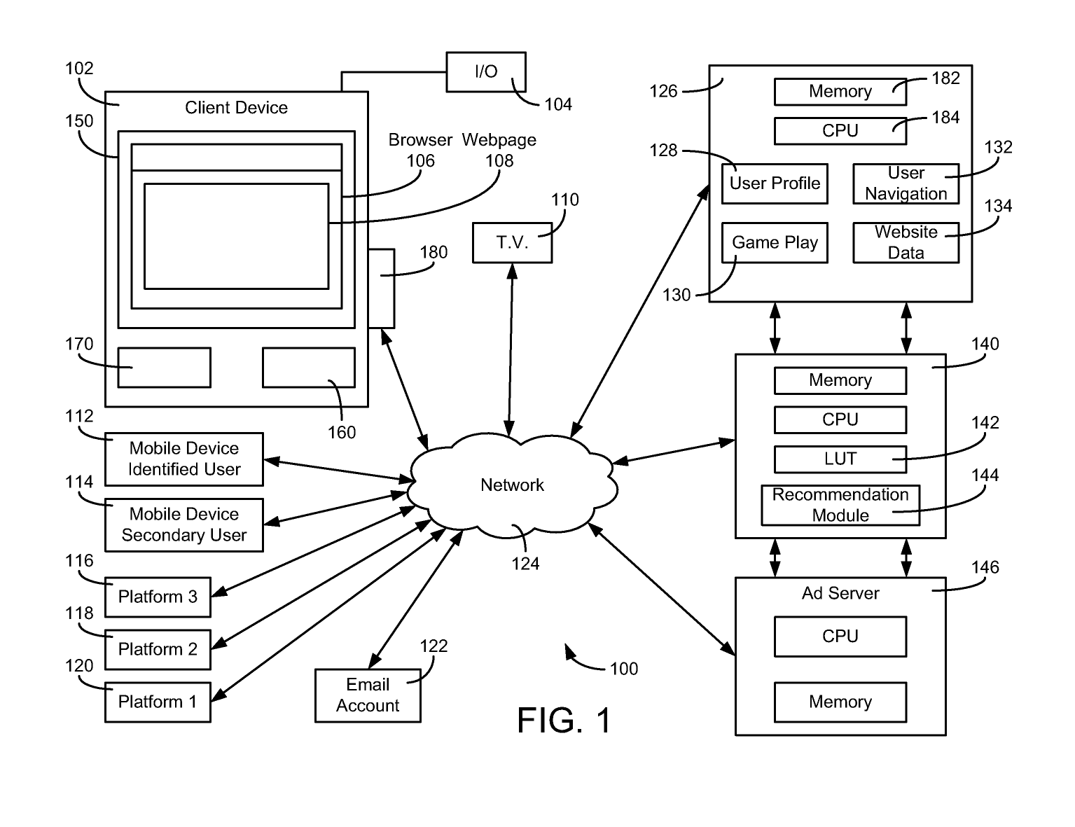

Referring to FIG. 1, a schematic diagram of a network environment 100 comprising a client-server architecture is shown that is used to collect user generated data, determine user-specific content such as user-specific recommendations, and distribute communications including the user-specific content according to one exemplary embodiment. Network environment 100 delivers content to client devices 102, 110, 112, 114, 116, 118, 120 and 122. The client devices may include mobile devices 112 and 114. A client device may also include a computing device 102 with a display 150 used to view a webpage 108 using a software browser application 106. The client devices may further include various video gaming devices or platforms 116, 118 and 120 used to facilitate interaction of a user with computer programs such as video games. The platforms themselves may comprise video game devices or consoles such as Xbox 360, PlayStation 3, Wii, Nintendo DS, an iPhone, an Android based platform, or a personal computer, according to various exemplary embodiments. Furthermore, network 124 may send and receive data to email accounts 122 and satellite or cable television subscribers 110.

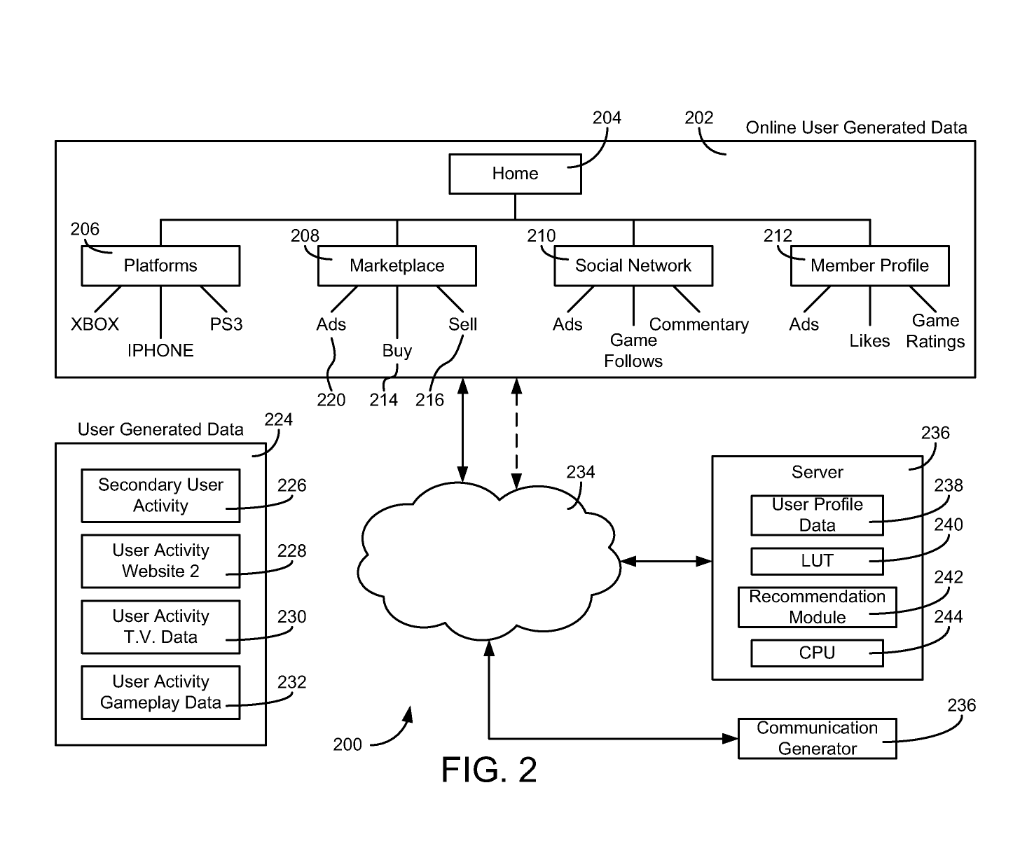

Client device 102 can include a processing circuit 160, a memory 170, a network interface 180, a user input element 104 as well as a display 150. The display 150 provides a browser window 106 which is provided on display 150 as a result of running a browser software application on client device 102. The browser window 106 displays internet content such as web pages from various websites to facilitate user interaction with the web pages. The websites may comprise product information websites or other content-based websites of different types (gaming content, product opinion content, website item purchase and sale content, sports content, news content, business content, etc.), such as www.cnet.com, www.bnet.com, www.cbssports.com, www.gamespot.com, etc. Furthermore, the websites may each be organized in a hierarchy as shown by element 202 in FIG. 2.

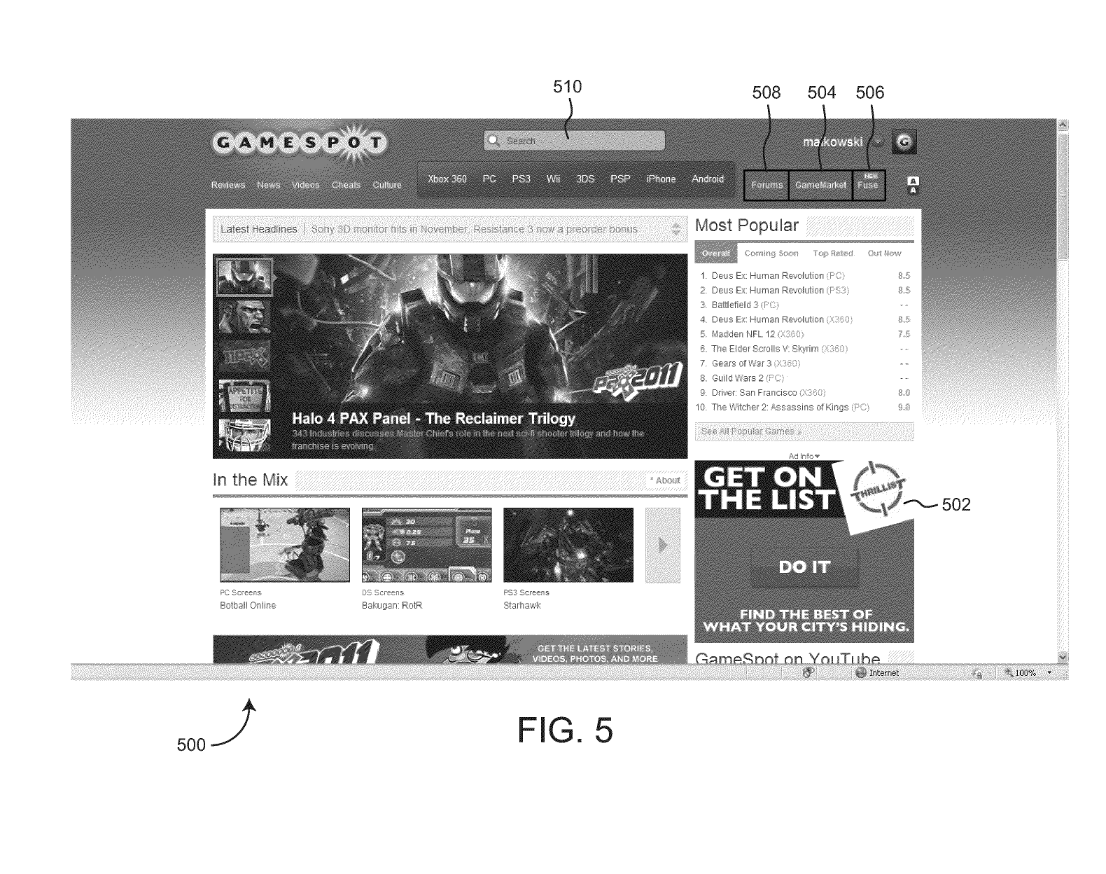

Specifically, a tree structure 202 for an exemplary website is shown in FIG. 2. Tree structure 202 represents a data structure stored in a memory (such as a database, file system, read only memory, etc.). Tree structure 202 may be in the form of a graph having nodes and edges between the nodes, or other hierarchy of information stored in memory. Tree structure 202 may comprise a home page 204 containing several categories of website content 206, 208, 210 and 212 accessible via hyperlinks on home page 204. Element 500 in FIG. 5 provides one example of home page 204. Furthermore, categories of website content 206, 208, 210 and 212 may be accessible through links 508, 504, and 506 on the home page.

For example, a product information website, such as www.gamespot.com, may comprise product information, product evaluations, opinion data, user commentary, and other data relating to a plurality of different products (such as electronics products, software products, network products, or other types of products). Tree structure 202 may comprise more than two, more than three, more than four, less than twenty, less than ten, or other numbers of levels. In this example, node 206 represents website items related to video game platforms or various systems on which video games can be played. Node 208 represents a website item marketplace where users may buy, sell and view advertisements for various website items. Element 600 displays one example of a web page represented by node 208.

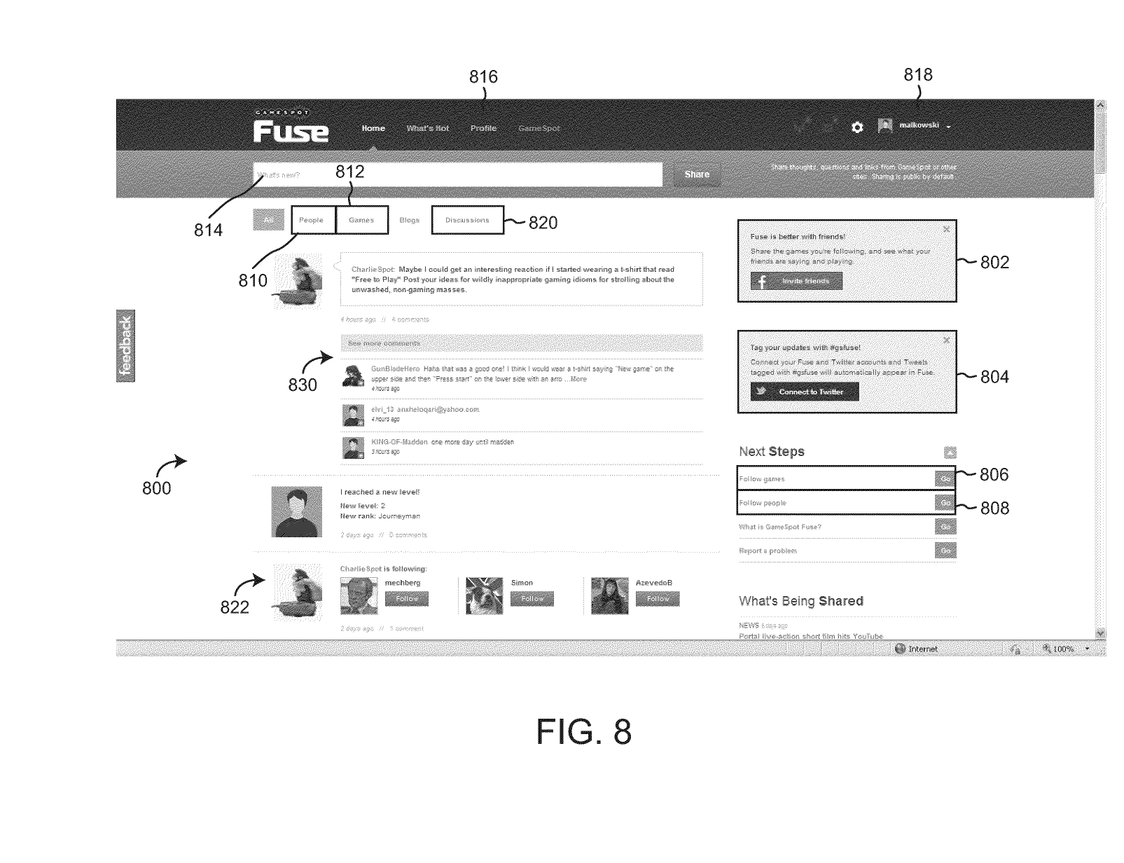

Node 210 represents a social networking aspect of the website wherein users may interact with each other, for example on web pages sorted by video game platform, video game, and/or subtopics relating thereto. Element 800 as shown in FIG. 8 displays one example of a web page represented by node 210. Node 212 represents a user profile that includes information particular to a registered user such as an identified user. A node identifier may be stored in memory for each node, along with a textual description of the node, data indicating its relationship(s) to other nodes, etc. Each of nodes 206, 208, 210 and 212 may have child nodes of their own such as child nodes 214, 216 and 220 representing product sub-categories within the product category represented by the node.

In FIG. 1, a user input element 104 may comprise one or more user interface elements to receive an indication of user input including audio, mechanical, visual, motion or other input. Each client device in FIG. 1 may communicate with computing devices such as other client devices or servers 126, 140 and 146 through one or more networks represented by element 124. Network element 124 may comprise a local area network (LAN), wide area network (WAN), a telephone network, such as the Public Switched Telephone Network (PSTN), a wireless link, an intranet, the internet, or combinations thereof. Client device 102, may be a mainframe, minicomputer, personal computer, laptop, personal digital assistant (PDA), cell phone, and the like. Client devices are characterized in that they are capable of being connected to the network 124 through a network interface 180.

Servers 106, 108 and 110 are typically computing devices having a processor 182 and a memory 184. The processing circuit 184 may comprise digital and/or analog electrical components (e.g., a microprocessor, application-specific integrated circuit, microcontroller, or other digital logic) configured to perform the functions described herein. The processing circuit may be a single server computer or a plurality of server computers, and may operate in a cloud computing environment, such as a shared, scalable computing environment. The memory 184 includes storage media, which may be volatile or non-volatile memory that includes, for example, read only memory (ROM), random access memory (RAM), magnetic disk storage media, optical storage media, flash memory devices and zip drives. Memory 184 may store data files associated with particular websites in a database format. For example, computing device 126 may be a server associated with a first website that stores website data in memory 134. Computing device 126 may also store data related to particular registered users' profile in memory 128, data related to a particular registered users game play in memory 130 and data related to a particular registered users navigation of a first website in memory 132. Additionally, user generated data such as data related to a variety of registered users' profiles, website navigation data and game play data may be stored in various other servers separate from website server 126. For example, game play data related to a particular registered user may be stored by a computing device owned by a third party prior to being communicated to computing device 140 to generate user-specific content.

Referring again to FIG. 1, computing device 140 may receive user generated data received from network connected devices 102, 112, 114, 116, 118, 120, 122, and 110 directly or from memory locations such as memory locations 182, 128, 132, 130 and 134. For example, user data may be retrieved from a user profile database such as that described in U.S. patent application Ser. No. 13/023,377 filed Feb. 8, 2011 entitled “Targeting Offers to Users of A Website,” which is incorporated by reference herein in its entirety. As another example, user data may be retrieved from a user data store such as that described in U.S. patent application Ser. No. 13/093,658 filed Apr. 25, 2011 entitled “User Data Store,” which is incorporated by reference herein in its entirety. Additionally, user generated data may be stored in a log as described in U.S. patent application Ser. No. 13/211,411 filed Aug. 17, 2011 entitled “Gaming Marketplace Apparatuses, Methods and Systems” which is incorporated by reference herein in its entirety. Computing device 140 may use the user generated data as input to either a look up table (LUT) 142 or a stored algorithm 144 or both to determine, select, or generate a plurality of user-specific content or user-specific recommendations.

The user-specific content may then be communicated to an identified user through network 124 in a variety of formats including email, website advertisements, website alerts, website display data, website messaging, website group admission suggestions, website social networking suggestions, website marketplace suggestions and automatically altering website settings for an identified user, according to one exemplary embodiment.

Furthermore, an identified user such as a registered website user may log on to a first website through client device 102. While logged in, the user may create first website user generated data such as website navigation data by commenting on an item included in the website such as a video game, or clicking on various links associated with a particular item included on the website, for example. Navigation data may also include other user interactions (e.g., what content the user has read or is reading, what the user clicked on, etc.) for various website items contained on the website. For example, if a user has searched for “cellular phones” using a search algorithm configured to search content available on the website, the user data may reflect one interaction with that particular website item. If a user has viewed product reviews for three different smartphones, the user data may reflect three user interactions with content associated with those particular website items.

This first website user generated data may be transmitted across network 124 and received at computing device 126 and stored in memory section 134, for example. According to one exemplary embodiment, the computing device 126 is a server. The user generated data may also be transmitted directly to computing device 140 as input to a recommendation LUT 142 or recommendation algorithm identified to determine user-specific content such as a plurality of recommendations.

In addition, user generated data may be non-website user generated data. In one exemplary embodiment, non-website user generated data can be collected from elements 116, 118, and 120. Elements 116, 118, and 120 may be video game platforms such as Xbox, Playstation, Game Cube, Nintendo, an Iphone, smartphone, or any other device capable of recording video game play data according to one embodiment. According to another embodiment, non-website user generated data can also be received from element 110. Non-website user generated data from element 110 may include television channels watched by a user, programs recorded by a user, or channels subscribed to by a user, for example. Furthermore, television data or video game play data may be collected from a website or non-website sources.

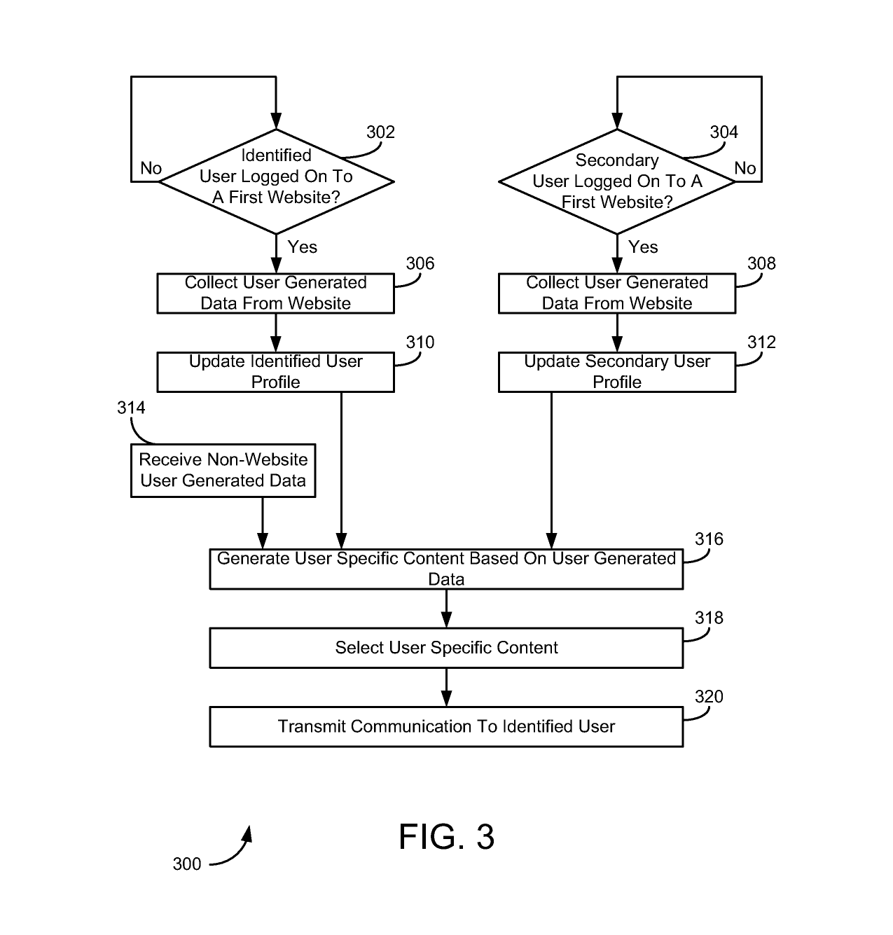

User-specific content may be generated based on the user generated data according to process 300 shown in FIG. 3. The user-specific content may include a list of website items determined to be relevant to the user. Website items may include products or services that appear directly on the website, linked from the website, or advertised on the website. Furthermore, website items may include other website users, or products and services depicted on other websites. For example, user-specific content may be a list of website items such as a list of video games that share common characteristics or a degree of relevance of a data item with the user generated data as determined by LUT 142 or algorithm 144. According to one embodiment, the LUT 142 or algorithm 144 may determine relevance to the user based at least in part on this user generated data, which may be stored in the form of a user profile.

Once one or more recommendations have been determined, a communication is generated and transmitted to the user. The communication may be an e-mail sent to email account 122, or displayed to the user accessing devices such as device 110, 102, 112, 114, 116, 118 or 120, for example. The communication may be generated to include the user-specific content (such as website items including products or services displayed on an internet website) or data related to user-specific content, such as a content item (e.g., a white paper, an article, a coupon, a suggestion for a game to purchase, etc.). According to one example, the user-specific content, such as a list of video games is provided to a communication generator to generate targeted communications based on at least one video game in the list of video games. For example, FIG. 3 depicts a general flow chart of a process 300 for collecting user generated data from identified users and a second or secondary users related to the identified users to generate a communication, such as a user-specific communication, based on the user generated data.

Process 300 may be carried out by a browser executable code stored in memory that is executed on a server 125, 140, 146, or on a client device 102, for example. In process 300, a user may access a first website using client device 102 so that display data from the webpage 108 is displayed on browser 106 on a display 150 of client device 102. For example, FIG. 5 depicts display data of a webpage 108 within a first website. Web pages 500, 600 or 800, for example, may be arranged in a website hierarchy such as hierarchy 202 depicted in FIG. 2 such that elements 204, 206, 208, 210 and 212 represent separate web pages.

Referring again to FIG. 3, process 300 may determine if users such as identified users and second users are logged onto a first website at step 302. An identified user may include any particular user who has previously registered or created an account with the first website, according to one exemplary embodiment. An identified user may also include any user network connected devices 110, 102, 112, 114, 116, 118 or 120, for example that is identifiable by the first website. The first website may identify a user by I.P. address, a stored user profile, or cookie data such as a unique cookie ID. For example, a user may be identified by a website using cookie data as that described in U.S. patent application Ser. No. 13/023,377, previously incorporated by reference.

Identified users may have several stored settings in a user account including but not limited to a profile page, a log of previous user activity, a log of previous user generated data, a log of user preferences compiled from non-website data such as video game play data, and a log of stored associations with second users, for example. Second users may include other registered users of the first website who have a stored association with an identified user. For example, if the first website includes a social network component where registered website users communicate with one another, second users may be registered website users in an identified user's social network. FIG. 8 depicts one example of a social network setting where identified users can initiate an association with a second user by following 808 another user, interacting with other registered users on a discussion board 830 or interacting with registered or non-registered users through third party social networks such as Facebook 802 or Twitter 804.

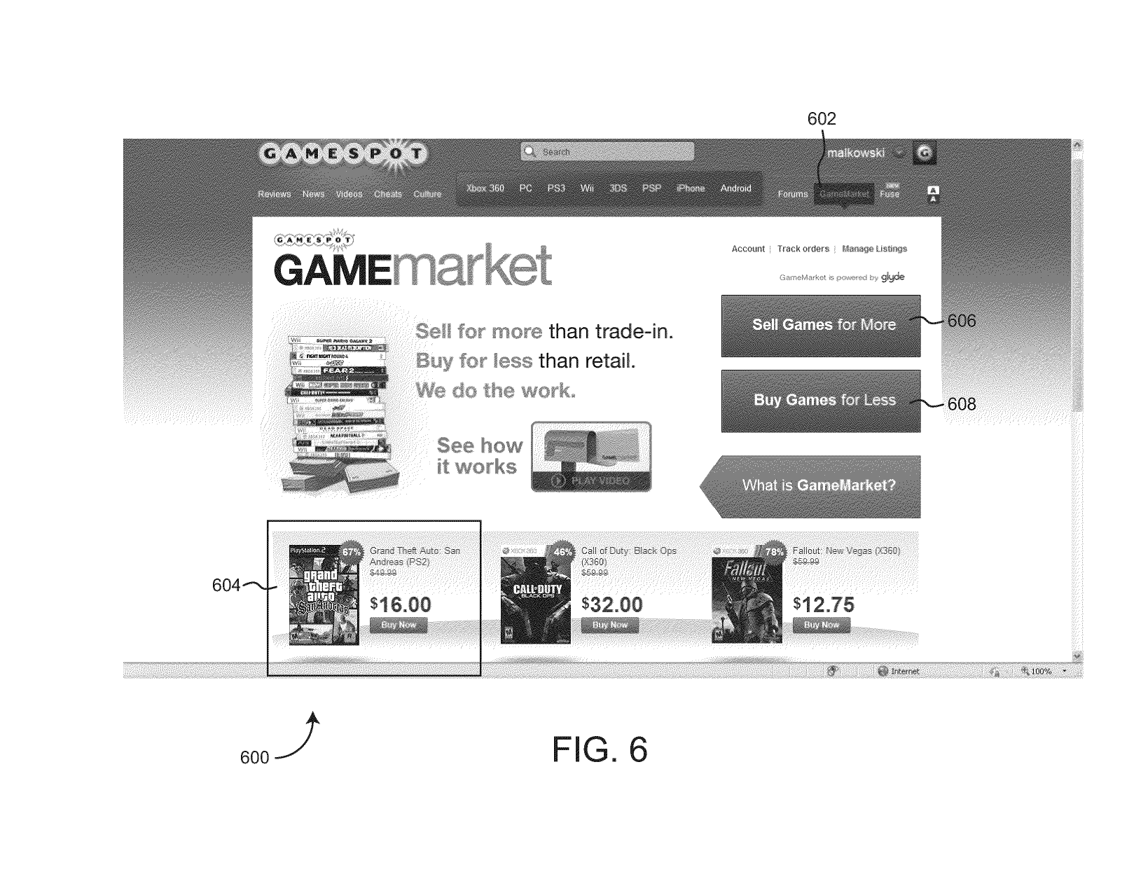

If it is determined an identified or second user is logged on at step 302 or 304, process 300 may collect the users website navigation at steps 306 and 308. The navigation data may include any user activity with respect to web page hierarchy 202 or any user activity on other websites accessed by a registered user that have clicked through to the other website from a link located on the first website. For example, navigation data may include a series of web page selections in hierarchy 202, a series of links clicked within web page in hierarchy 202, interactions on a social network web page 210, purchases and sales made on or facilitated by the first website, particular articles or video content viewed by an identified or second user, or products or services explicitly or implicitly indicated as being of interest to a user. In the context of video games, a user may indicate interest by discussing the game on discussion board 800 shown in FIG. 8. User navigation data may also include a user “following” a game 808, which may include receiving regular updates regarding a particular game, by rating or reviewing a game, or by purchasing or selling a game through links 604, 606, or 608 as shown in FIG. 6.

Referring again to FIG. 3, once user activity is detected at steps 306 and 308 the user generated data is collected and optionally stored at steps 306 and 308. For example, the user generated data may be transmitted across network 124 and stored at memory 182 of computing devices 126, 140 and 146. The user generated data may also be used to immediately update a user profile 128 stored on a computing device at steps 310 and 312, for example. In an alternative embodiment, steps 310 and 312 are omitted and the user generated data collected at steps 306 and 308 is directly transmitted as input to a LUT 142 or recommendation algorithm 144 to generate a plurality of user-specific recommendations at step 316.

Furthermore, at step 314, additional non-website data is received at one of a computing device 126, 140, 146, a LUT 142, or a recommendation algorithm 144, for example. This additional non-website data may include third party data collected from peripheral devices 102, 112, 114, 116, 118, 120, 110 and 122. The non-website data may include cable television data, satellite television data, mobile phone data, email account data, movie subscription data, or video game play data, for example. Specifically, elements 116, 118 and 120 may be video game platforms such as Xbox, Playstation, Game Cube, Nintendo, an Iphone, smartphone, or any other device capable of recording video game play data according to one embodiment.

According to one embodiment, the non-website user generated data itself may include television channels watched by a user, programs recorded by a user, channels subscribed to by a user, the type of platform used to play a video game, the amount of time a video game has been played, the video game being played, and event specific data that occurred during execution of the video game such as the users' progress within a particular video game. Video game play data for example, may be associated with a user registered with the first website by using various identification methods such as IP address, social security number, name, user ID or any other method of identification. According to one exemplary embodiment, the video game play data is imported into a users account through application programming interface calls (API) to locally stored data.

For example, the video game play data may be collected from a first website 202, third party websites providing streaming video games or non-streaming video games, or video game consoles 116, 118 or 120 connected to network 124. Accordingly, the video games may be executed on a server and transmitted to a client device or executed on a video game console such as consoles 116, 118 and 120. The video game play data may include a genre of video game, how long the video game has been played for, or how far a user has advanced in the video game. The video game play data may be transmitted directly to servers 126, 140 and/or 146, extracted from a data file into servers 126, 140 and 146, or manually entered into the servers. The data collected can include other data from peripheral devices 110, 102, 112, 114, 116, 118, and 120 such as television subscription data from television input 110. As described in further detail below, this user-generated data can be used to provide user-specific feedback to an identified user through websites, email messages, web page advertisements, social media recommendations, or information on products or services for example. The feedback can be provided through the first website 202 or through third parties such as cable providers, other websites, advertisers, and providers of any other product or service through network 124 to an identified user making use of a network connected peripheral device 110, 102, 112, 114, 116, 118, and 120.

Once the at least one of the non-website user generated data and the first website user generated data has been received as input to a LUT 142 or recommendation identified, user-specific data such as a plurality of recommendations are generated at step 316. According to an exemplary embodiment, data such as indications of overall popularity of a website item such as sales numbers, user ratings, or click throughs may be input to a LUT or recommendation module at step 316 to generate user-specific recommendations. The user-specific content may by categorized such that at least one user-specific content is generated per category. For example, user-specific content may be generated for categories such as recommended games to purchase, recommended games to sell, recommended movies to watch, recommended friends to add to an identified users social network, or any other type of category related to website items.

Furthermore, step 316 may generate a user-specific content for each category. Once user-specific content such as a plurality of user-specific recommendations have been generated at step 316 according to a degree of relevance to a particular user such as an identified user, the list of user recommendations may be optionally narrowed at step 318 prior to generation of a communication at step 320. Step 318 may select a category of user-specific recommendations, select only the most relevant recommendation to a particular user as determined by a recommendation algorithm, select common recommendations between multiple categories, select common recommendations between various users, or a combination of recommendation selection techniques.

At step 320, the generated and/or selected user-specific content is transmitted to the identified user. At step 320, a computer system such as computing device 140 determines that a message is to be generated, for example as part of a messaging campaign, periodic update, targeted advertisement, etc. Users who have registered with the first website may be listed by user IDs to organize the generation of the user-specific messages. For example, a list of user IDs of registered users or users who have signed up for or opted-in to receipt of the message at the first website may be used be step 320 to generate a user-specific communication. Step 320 may be performed at a computing device 140 or an advertising server 146.

The communications generated at step 320 may be sent to any one or several of peripheral devices 102, 112, 114, 116, 118, 122, and 110 through network 124. The communication may incorporate links, product offers or a suggestion to join a group related to a generated recommendation. The communication may also be in one or more formats, such as a newsletter, e-mail message, alert, or website display data at various predetermined locations in the website hierarchy such as element 502 in FIG. 5, or element 604 in FIG. 6. The communication may also be in the form of a targeted advertisement including links to product offer websites or other merchant websites selling products or services. The targeted advertisement may further comprise one or more of a product name, product description, offer URL, price of offer, merchant name, merchant rating, an image of the product, etc., and may be provided in XML format, for example.

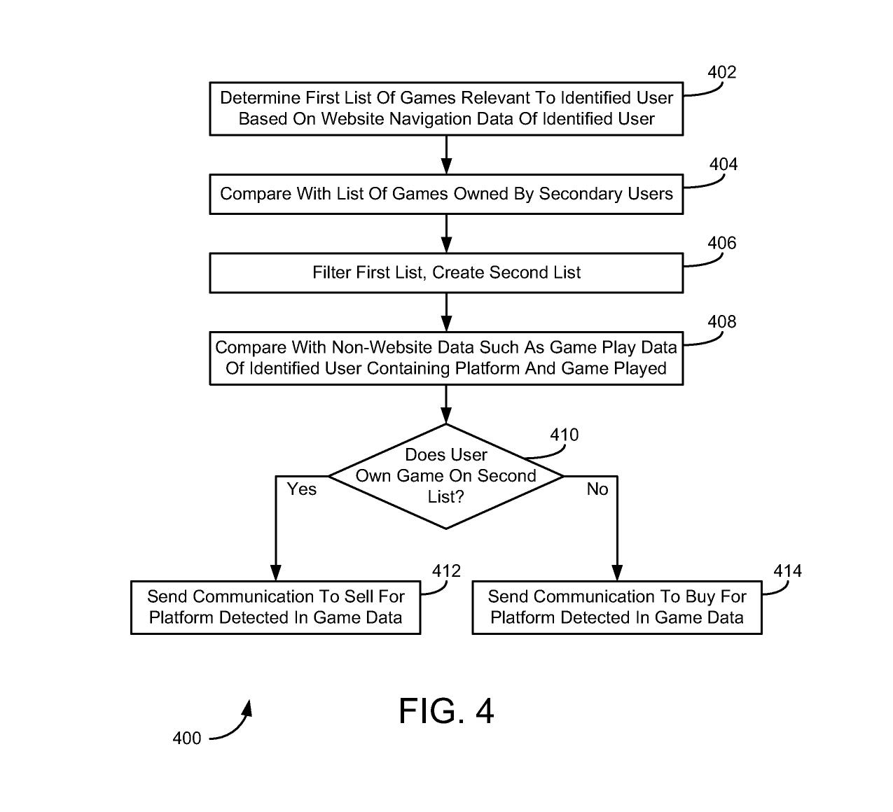

Referring to FIG. 4, a general method of generating a communication to an identified user depicted in process 300 may be used to communicate a recommendation to buy or sell a website item, such as a video game, on a first website 202. For example, in FIG. 4 at step 402 the identified user website generated data may include a list of website items such as video games. The list may be compiled through monitoring an identified users' website navigation data such as the identified user selecting a link associated with particular website items such as video games. Process 400 may also optionally modify the website item list compiled in step 402 at steps 404 and 406 by comparing the website item list with another website item list such as a list of video games owned by second users or a list of the highest selling video games. At step 408, the website user generated data from step 402 may be compared with non-website user generated data, such as video game play data of the identified user.

The video game play data of the identified user may be data collected from network connected devices 102, 112, 114, 116, 118, and 120. Devices 116, 118, and 120, for example may be used by the identified user to execute video games. The game play data generated by an identified user accessing devices 116, 118 and 120 may be collected and later received at recommendation algorithm 144 at step 408. The game play data may include the type of platform used to play a video game, the amount of time a video game has been played, the video game being played, and event specific data that occurred during execution of the video game such as the users progress within a particular video game. The recommendation algorithm represented by element 144 may carry out steps 408 to determine if a particular website item such as a video game is of interest to an identified user, and if so, whether the identified user already owns the video games the user is interested in at step 410. In the exemplary embodiment shown in process 400, the recommendation algorithm may provide alternate recommendations 412 and 414 based on the website user generated data and the non-website user generated data received at steps 402 and 408, respectively. Accordingly, some user generated data is passive in nature in that a process such as process 300 can determine what advertisements, video games, website content, should be displayed to a user without direct input from the user on what content to select.

For example, if the recommendation algorithm determines a user has indicated interest in a particular video game based on user generated website data and also determines the user does not own that game based on non-website data such as video game play data, the recommendation algorithm may recommend the user buy that video game at step 414 in the form of a generated communication such as a targeted advertisement. The targeted advertisement 502 may be located on a web page 500 within website hierarchy 202. The generated communication may also provide a link to element 608 to facilitate an identified users purchase of that particular video game. Alternatively, if the recommendation algorithm determines a user has indicated interest in a particular video game based on user generated website data and also determines the user does own that game based on non-website data such as video game play data, the recommendation algorithm may recommend the user sell that video game at step 412 in the form of a generated communication such as a targeted advertisement. The targeted advertisement 502 may be located on a web page 500 within website hierarchy 202. The generated communication may also provide a link to element 606 to facilitate an identified users sale of that particular video game.

In addition to generating communications to the identified user, process 700 may be implemented to alter the user profile of an identified user or to include the identified user in particular groups of users on website 202. For example, the group of users may be a “game follow” group made up of registered users that receive updates, tips, news, alerts, or other information associated with a particular video game or particular type of video game. At step 702, process 700 receives identified user website generated data such as identified user website navigation data, for example, to determine a particular users level of interest in a website item, such as a video game or a particular type of video game.

This website user generated data can optionally be compared with second user generated data to further refine or expand the website user generated data at step 704. At step 706, process 700 may determine a user-specific recommendation according to one of a recommendation algorithm or LUT. The user-specific recommendation may include selecting a particular group the identified user is likely to be interested in joining such as a “game follow” group for a website item such as a video game. Once a group is selected, process 700 may alter an identified users' settings and automatically enter the identified user into the selected group at step 708.

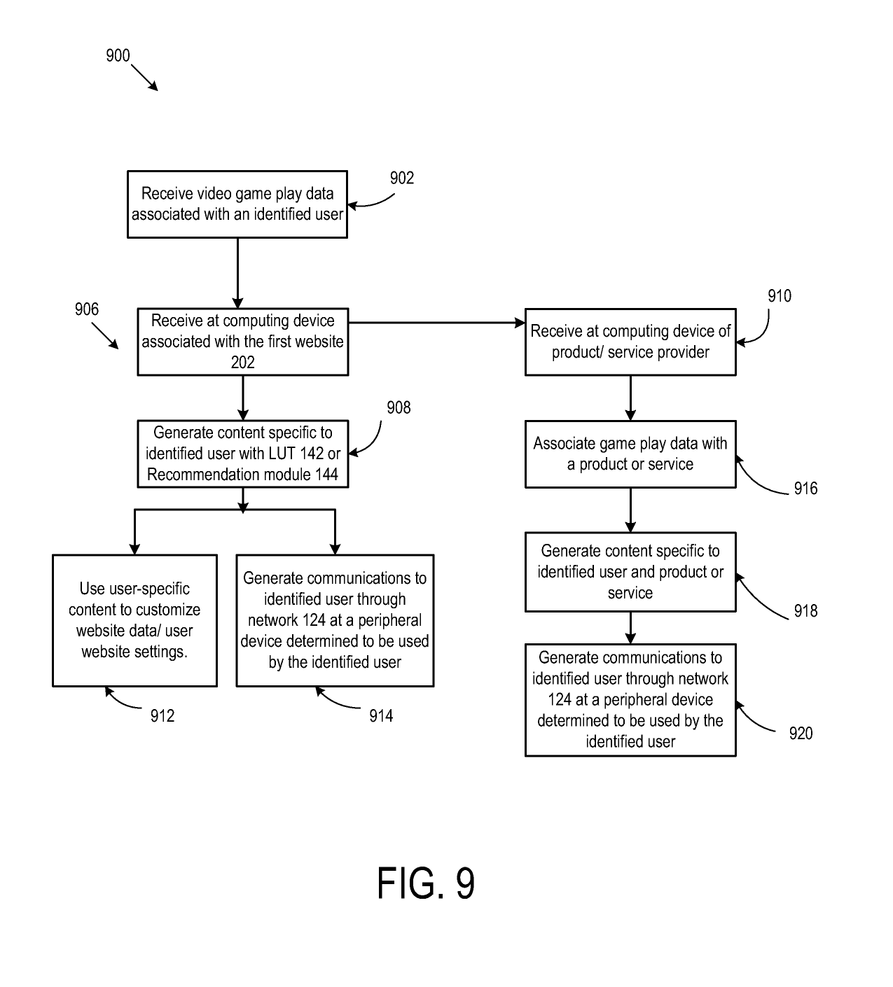

Additionally, user generated data such as video game play data and television subscription data can be received and used to customize a first website 202. User generated data may also be provided to third parties that provide service to peripheral devices 110, 102, 112, 114, 116, 118, and 120 through network 124 according to process 900 depicted in FIG. 9. According to one embodiment, the user generated data such as video game data can be received at a server 126 associated with the first website or to a third party server 146 at step 902. The user generated data derived from video game play or television subscription data can be received at a computing device such as server 126 associated with the first website 202 at step 906. The website 202 may directly collect this data through user input at a client device at step 906. Additionally, the website 202 may receive this data at step 902 from a third party data collection company that collects user generated data from peripheral devices 110, 102, 112, 114, 116, 118, and 120, for example. Once the video game play data is received at computing device 126, the video game play data may be used to generate content specific to an identified user at step 908.

Following step 908, the content specific to an identified user can be used as feedback to customize a first or other website that an identified user logs on to at step 912. Examples of customization may include altering a users profile, targeted advertisements, automatically entering the user into a game follow group, changing user settings, or recommending the identified user communicate with another user who has similar video game playing or television subscription data. In addition, a server associated with a first website 202 may generate a communication to a peripheral device used by an identified user through network 124 at step 914.

Alternatively or in addition, the video game play data may be shared with a third party product or service provider at step 910. The video game play or television subscription data provided to a third party server may be used to identify a product or service likely to be of interest to the identified user at step 916. Once the video game play data is received at a third party computing device, such as server 146 the video game play data may be used to generate content specific to an identified user at step 918.

After step 918, a third party can then transmit a communication to a peripheral device connected to network 124 when an identified user is recognized by an identification means at step 920. For example, a third party server or other computing device associated with a sports and entertainment ticket provider may analyze the video game play or television subscription data and determine an identified user has played a basketball video game and a football video game in the last six months. Based on this data, the third party may generate a communication to the identified user over network 124 offering discounted football or basketball tickets to a sporting event in proximity to the location of the identified user. The location may be determined by using the identified users' IP address, for example.

In addition, LUT 142 or recommendation algorithm 144 at a computing device such as a server may be used to accept user generated data from multiple sources including video game play data and TV subscription data to determine user-specific content for a communication. For example, a message in some cases may only be generated by website 202, a third party website, or a service provider if video game play data matches television subscription data, such as a subscription to a particular sports channel or channels.

It should be noted that the server is illustrated and discussed herein as having various modules which perform particular functions and interact with one another. It should be understood that these modules are merely segregated based on their function for the sake of description and represent computer hardware, circuits and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, etc. Additionally, a computer may be embedded in a device not generally regarded as a computer but with suitable processing capabilities, including a Personal Digital Assistant (PDA), a smartphone or any other suitable portable or fixed electronic device.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.” While specific embodiments have been disclosed, the various embodiments are not to be considered limiting. One of ordinary skill in the art will understand that variations and modifications flow from the teachings provided herein.

1. A method of generating a communication for a user of an internet website, the method comprising:
identifying a user of the interne website;
receiving video game play data;
storing the video game play data in a user profile associated with the identified user;
selecting, using a processing circuit, user-specific content based on the video game play data, wherein the user-specific content comprises a recommendation to sell a product;
generating a communication for the identified user comprising the user-specific content; and
transmitting the communication to the identified user.

2. The method of claim 1, wherein the received video game play data is associated with the identified user.

3. The method of claim 1, wherein the communication transmitted to the identified user is transmitted by a non-website messaging service.

4. The method of claim 1, wherein the user-specific content is selected using one of a recommendation module or recommendation look up table.

5. The method of claim 1, wherein the user-specific content comprises a recommendation to sell a product that video game play data indicates the identified user owns..

6. The method of claim 2, wherein the video game play data includes at least one of the platform used to play the video game, the amount of time a video game has been played, the video game being played, and event specific data recorded during execution of the video game.

7. The method of claim 2, wherein the video game play data is derived from a video game executed on a server.

8. The method of claim 2, wherein the video game play data is derived from a video game executed on a video gaming device.

9. The method of claim 1, wherein the communication to the identified user includes at least one of a recommendation to join a group of users on the first website, an advertisement for an item included on the first website, an advertisement for an item that is not included on the first website, and a link to at least one item included on the first website.

10. The method of claim 5, wherein the product is a video game and the video game play data comprises at least one of video game data generated by the identified user and video game data generated by a second user associated with the identified user.

11. The method of claim 1, further comprising:
receiving website user generated data;
wherein the user-specific content is also based on the website user generated data.

12. The method of claim 11, wherein the website user generated data comprises at least one of registered user navigation data, a recorded purchase by the registered user, social network data, and a rating of an item included on the first website assigned by the registered user.

13. The method of claim 1, wherein the communication to the identified user is included in display data on a web page in the hierarchy of the internet website.

14. The method of claim 1, wherein the communication is received by the identified user from an advertising server.

15. A method of generating a communication for a registered user of an internet website, the method comprising:
identifying the registered user of the internet website;
receiving video game play data associated with the identified registered user;
determining, using a processing circuit, a group of registered users associated with at least one item included on the internet website based on the video game play data;
including the registered user in the group of registered users associated with at least one item included on the internet website; and
selecting, using a processing circuit, user-specific content for transmitting to the identified registered user, based on the video game play data wherein the user-specific content comprises a recommendation to sell a product.

16. The method of claim 15, wherein the group of registered users receive information about a particular video game.

17. A method of generating a communication for a user of an internet website, the method comprising:
identifying a user of the internet website;
receiving video game play data from a second user associated with the identified user;
storing the video game play data in a user profile associated with the identified user;
selecting, using a processing circuit, user-specific content based on the non-website user generated data, wherein the user-specific content comprises a recommendation to sell a product;
generating a communication for the identified user comprising the user-specific content; and
transmitting the communication to the identified user.

18. The method of claim 17, wherein the communication transmitted to the identified user is transmitted by a non-website messaging service.

19. The method of claim 17, wherein the user-specific content comprises a recommendation to purchase a product in the case that the video game play data indicates the second user owns the product.

20. The method of claim 17, wherein the video game play data includes at least one of the platform used to play the video game, the amount of time a video game has been played, the video game being played, and event specific data recorded during execution of the video game.

21. The method of claim 17, wherein the communication to the identified user includes at least one of a recommendation to join a group of users on the first website, an advertisement for an item included on the first website, an advertisement for an item that is not included on the first website, and a link to at least one item included on the first website.

22. The method of claim 17, further comprising receiving website user generated data and further wherein the user-specific content is also based on the website user generated data.

23. The method of claim 22, wherein the website user generated data comprises at least one of registered user navigation data, a recorded purchase by the registered user, social network data, and a rating of an item included on the first website assigned by the registered user.

24. The method of claim 17, wherein the communication to the identified user is included in display data on a web page in the hierarchy of the internet website.

25. The method of claim 17, wherein the communication is received by the identified user from an advertising server.

26. One or more non-transitory computer-readable media with machine-executable instructions stored thereon and when executed by one or more processors implements a method comprising:
identifying a user of the internet website;
receiving video game play data from a video gaming device;
storing the video game play data in a user profile associated with the identified user;
selecting, using a processing circuit, user-specific content based on the non-website user generated data, wherein the user-specific content comprises a recommendation to sell a product;
generating a communication for he identified user comprising the user-specific content; and
transmitting the communication to the identified user.
